(19) United States
(12) Patent Application Publication
(10) Pub. No.: US 2023/0020145 A1
(43) Pub. Date: Jan. 19, 2023

(54) METHOD FOR PROVIDING COACHING SERVICE BASED ON HANDWRITING INPUT AND SERVER THEREFOR

(71) Applicant: DAEKYO CO., Ltd., Seoul (KR)

(72) Inventor: Ho Jun KANG, Seoul (KR)

(21) Appl. No.: 17/862,735

(22) Filed: Jul. 12, 2022

(30) Foreign Application Priority Data
Jul. 13, 2021 (KR) 10-2021-0091359

(51) Int. Cl. G09B 7/04; G06V 30/22

(52) U.S. Cl. CPC G09B 7/04; G06V 30/22

(57) ABSTRACT

A method for providing a coaching service based on a handwriting input and a server therefor are disclosed. The method includes receiving handwriting input information of a learner from a learner interface, detecting a behavioral pattern of the learner based on the handwriting input information and information on a learning item which the learner performs learning, determining whether there is an abnormality in the behavioral pattern, and obtaining a feedback based on a determination result about the abnormality.

### CROSS-REFERENCE TO RELATED APPLICATIONS

The application claims priority to and the benefit of Korean Patent Application Number 10-2021-0091359, filed Jul. 13, 2021 in the Korean Intellectual Property Office, the entire contents of which is incorporated herein by reference for all purposes.

### TECHNICAL FIELD

The present disclosure relates to a method for providing a coaching service based on a handwriting input and a server therefor.

### BACKGROUND

The information disclosed below in the Background section is to aid in the understanding of the background of the present disclosure, and should not be taken as acknowledgement that this information forms any part of prior art

As non-face-to-face learning increases, a non-face-to-face learning platform that provides appropriate learning services by mirroring learners' learning images is being developed. Such a non-face-to-face learning platform collects specific learning data from learners and performs big data analysis to provide learning services.

Meanwhile, most learners perform learning while using handwriting input for various reasons, such as arranging learning contents, taking notes, or marking on a problem, and accordingly have various behavioral patterns related to the handwriting. However, conventional non-face-to-face learning platforms have a problem in that since it is difficult to continuously monitor whether there is an abnormality in the behavioral pattern related to a learner's handwriting input due to the limitation of the non-face-to-face learning, bad habits of the learner related to the handwriting input could not be properly corrected.

### SUMMARY

According to at least one aspect, the present disclosure provides a method, performed by a device, for providing coaching service. The method includes receiving handwriting input information of a learner from a learner interface, detecting a behavioral pattern of the learner based on the handwriting input information and information on a learning item which the learner performs learning, determining whether there is an abnormality in the behavioral pattern, and obtaining a feedback based on a determination result about the abnormality.

According to at least one aspect, wherein the obtaining the feedback includes sending the behavioral pattern and the handwriting input information to a coach interface; and receiving a comment related to the behavioral pattern from the coach interface as the feedback.

According to at least another aspect, the present disclosure provides a coaching service server. The coaching service server includes one or more programmable processors, and a computer readable storage coupled to the one or more programmable processors and having instructions stored therein, wherein the instructions, when executed by the one or more programmable processors, cause the one or more programmable processors to receive handwriting input information of a learner from a learner interface detect a behavioral pattern of the learner based on the handwriting input information and information on a learning item which the learner performs learning, determine whether there is an abnormality in the behavioral pattern, and obtain a feedback based on a determination result about the abnormality.

### BRIEF DESCRIPTION OF THE DRAWINGS

FIG. 1 is a block diagram illustrating a coaching service platform according to one embodiment of the present disclosure.

FIGS. 2A and 2B are exemplary diagrams illustrating handwriting input information according to one embodiment of the present disclosure.

FIGS. 3A and 3B are exemplary diagrams for illustrating a method of detecting a behavioral pattern of a learner based on handwriting input information according to one embodiment of the present disclosure.

FIG. 4 is an exemplary diagram illustrating a coach interface according to one embodiment of the present disclosure.

FIG. 5 is a flowchart illustrating a coaching service providing method according to one embodiment of the present disclosure.

### DETAILED DESCRIPTION

The present disclosure in some embodiments may provide a coaching service providing method and a server therefor, capable of obtaining a learner's handwriting input information from a learner interface, detecting the learner's behavioral pattern, and determining whether there is an abnormality in the learner's behavioral pattern.

Further, the present disclosure in some embodiments may provide a coaching service providing method and a server therefor, capable of obtaining feedback based on a learner's behavioral pattern and a result of determining whether there is an abnormality in the learner's behavioral pattern.

Features achievable by embodiments of the present disclosure are not limited to the above-mentioned features, and other features not mentioned may be clearly understood by those skilled in the art from the following description.

Hereinafter, some embodiments of the present disclosure are described in detail with reference to the accompanying drawings. In the following description, like reference numerals designate like elements, although the elements are shown in different drawings. Further, in the following description of some embodiments, a detailed description of related known components and functions when considered to obscure the subject of the present disclosure are omitted for the purpose of clarity and for brevity.

In describing the components of the embodiments, alphanumeric codes may be used such as first, second, i), ii), a), b), etc., solely for the purpose of differentiating one component from others but not to imply or suggest the substances, the order, or sequence of the components. Throughout the present disclosure, when parts “include” or “comprise” a component, they are meant to further include other components, not to exclude thereof unless there is a particular description contrary thereto. When a component, device, element, unit, module, or the like of the present disclosure is described as having a purpose or performing an operation, function, or the like, the component, device, element, unit or module should be considered herein as being “configured to” meet that purpose or to perform that operation or function.

The description of the present disclosure to follow in conjunction with the accompanying drawings is intended to describe exemplary embodiments of the present disclosure and is not intended to represent the only embodiments in which the technical idea of the present disclosure may be practiced.

In the present disclosure, a user interface may be a physical medium or virtual medium implemented for the purpose of temporary or permanent access for interaction between a user and a thing or system (e.g., device, computer program, etc.). The user interface may refer to how a website or application program interacts with a learner, for example.

The user interface may include at least one input unit that can be manipulated by a user and at least one output unit that displays a result of the user's use. The user interface may include at least one object designed to interact with a user, such as a display screen, a keyboard, a mouse, text, an icon, and help. The user interface may be, for example, a web user interface (WUI), a graphical user interface (GUI), a command line interface (CLI), a touch user interface, a communication interface agent, a crossing-based interface, a gesture interface, an object-oriented user interface, a movement tracking interface, a multi-screen interface, a voice user interface, an end user interface, or the like, but is not limited thereto.

The user interface is a device loaded with a program designed to interact with a user and may be a personal computer (PC), a laptop, a smart phone, a tablet, a personal digital assistant (PDA), a game console, a portable multimedia player (PMP), a wireless communication terminal, a TV, a media player, or the like, but is not limited thereto.

A coaching service providing method of the present disclosure may be executed by a coaching service server, and the coaching service server may be executed on a computing device. The coaching service server may perform each function through one or more processors available to the computing device, and may include a computer-readable storage having instructions stored therein in connection with the processors.

A coaching service platform in the present disclosure may be Daekyo's USM platform, but is not limited thereto.

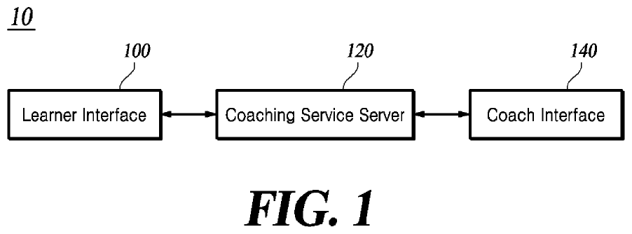

FIG. 1 is a block diagram illustrating a coaching service platform according to one embodiment of the present disclosure.

The coaching service platform 10 according to one embodiment of the present disclosure may include all or part of a learner interface 100 that is a user interface used by a learner, a coaching service server 120, and a coach interface 140 that is a user interface used by a coach. The coaching service platform 10 shown in FIG. 1 is exemplified as one embodiment of the present disclosure, and not all components shown in FIG. 1 are essential components, and some components may be added, changed, or deleted in another embodiment. For example, in another embodiment, the coach interface may be replaced with a coaching AI (Artificial Intelligence) device (not shown) that provides feedback on a learner's behavioral pattern by learning the feedback previously provided by the coaches.

The learner interface 100 may be a user interface that can receive and display a learner's handwriting, and transmits learner's handwriting input information to the coaching service server 120. The learner interface 100 may transmit the handwriting input information to the coaching service server 120 in real time. Here, the handwriting input information may be information related to a handwriting input of a learner into the learner interface 100 while learning. For example, the handwriting input information may be a learning screen of the learner interface 100 on which a learner's handwriting input may be displayed.

The learning screen may be transmitted to the coaching service server 120 as a still image or a video image. Alternatively, the learner interface 100 may transmit the learning screen of the learner and a handwriting input signal received from the learner as handwriting input information to the coaching service server 120. The learner interface 100 may transmit a still image or a dynamic image of a learning screen on which a learner's handwriting input can be displayed, or transmit a still image or a dynamic image of the learning screen and handwriting input signals to the coaching service server 120 by using mirroring technology.

The learner interface 100 may transmit to the coaching service server 120 all or part of the handwriting input information from immediately after the learner's learning starts until the learning ends. Alternatively, the learner interface 100 may transmit the corresponding handwriting input information to the coaching service server 120 in response to determining that there is a singularity in the learner's handwriting input information. Here, the learner interface 100 may determine whether there is a singularity in the learner's handwriting input information based on the pre-stored handwriting input information of other learners.

The learner interface 100 may receive feedback on the behavioral pattern of the learner analyzed based on the handwriting input information from the coaching service server 120 or the coach interface 140.

The coaching service server 120 may receive the learner's handwriting input information from the learner interface 100, detect the learner's behavioral pattern based on the handwriting input information and information of a learning item which the learner performs learning, and determine whether there is an abnormality in the behavioral pattern. Here, the information of the learning item is information related to the learning item that the learner learns. The learning item information may include, for example, all or part of classification information of the learning item, preset problem solving time of the learning item, a manner of displaying the learning item (e.g., a learning item display area and an answer area on the learning screen, etc.), an answer entry type (e.g., number, numeric answer display manner, mathematical formula, short answer type, narrative answer type, multiple choice type), and correct answer information, but is not limited thereto, and any information related to the learning item, which is available to detect a behavioral pattern of a learner, may be used as the information of the learning item in the present disclosure.

Hereinafter, it is described on the premise that the handwriting input information is a learning screen on which the handwriting input may be displayed, or a learning screen and a handwriting input signal, but this is merely for convenience of explanation.

The coaching service server 120 may determine that there is an abnormality in the behavioral pattern of the learner in response to detection of the behavior pattern corresponding to a case where it is determined that the learner is not trying to solve a learning question properly.

The coaching service server 120 may analyze an image and/or handwriting input signal of the received learning screen and detect a case where it is determined that no handwriting input exists on the learning screen within a problem solving reference time of the learning item learned by the learner, and may determine that there is an abnormality in the learning state. The coaching service server 120 may detect a case where it is determined that there are many handwriting inputs on the learning screen compared to the correct answer information of the learning item, and may determine that there is an abnormality in the learning state. The case where it is determined that there are many handwriting inputs may be, for example, a case where there is a handwriting input (or handwriting input signal) of more pixels than required for answering and solving processes, or a case where an answer area and a non-answer area on the learning screen are distinguished and handwriting other than the handwriting identified as the solving process is further included in the non-answer area. The coaching service server 120 may detect a case where the handwriting input on the learning screen is determined to be earlier compared to the preset problem solving reference time, and may determine that there is an abnormality in the learning state.

The coaching service server 120 may detect a case where the type of the handwriting input on the learning screen is determined to be different from an answer description type of the learning item, and may determine that there is an abnormality in the learning state. For example, when the answer description type of the learning item is a number or a number to be input based on decimal places, the coaching service server 120 identifies the type of handwriting input from the handwriting input information. The coaching service server 120 may determine that the type of handwriting input is different from the answer description type in cases of determining that as a result of the identification, the handwriting input is not a number or a mathematical expression, does not include a decimal point, and/or has an abnormality in the position of the decimal point.

The coaching service server 120 may further identify the learner's answer and handwriting other than the answer from the handwriting input information by using the answer area information on the learning screen as information on the learning item. The coaching service server 120 may determine that the type of handwriting input is different from the answer description type when it is determined that the type of the learner's answer is different from the type of learning item, and/or that the handwriting type other than the learner's answer is different from the type for deriving the corresponding answer type (e.g., mathematical expression, logical expression, etc.).

The coaching service server 120 may distinguish the learner's answer area and the non-answer area from the handwriting input on the learning screen based on the answer area of the learning item. The coaching service server 120 may determine that there is an abnormality in the learner's learning state in response to detection of a case where it is determined that the handwriting input on the non-answer area is not a process of solving the learning item.

For example, the coaching service server 120 may identify a handwriting input on the non-answer area as a process of solving the learning item and detect a case where it is determined that there is an error in all or part of the solving process, and may determine that there is an abnormality in the learner's learning state. The case where it is determined that there is an error in the solving process may be, for example, a case where there is an error in the calculation of mathematical expressions in the process of solving the problem or in the process of deriving logical expressions, and the like.

The coaching service server 120 obtains feedback on the determination result. The coaching service server 120 may use, for example, a pre-stored feedback table and obtain data of the feedback table matching the detected behavioral pattern and the abnormality determination result as feedback. The coaching service server 120 may obtain feedback using a feedback model that has previously trained the behavioral patterns and abnormality determination results of various learners. Such training may be based on machine learning or deep learning, and may be online-learning, that is, learning of a method of updating the model by learning the collected data in real time.

The coaching service server 120 may provide feedback to the learner by transmitting the learner's behavioral pattern and the learner's handwriting input information to the coach interface 140 as a result of the determination. Specifically, the coaching service server 120 may transmit handwriting input information received from the learner interface 100 to the coach interface 140 directly or in real-time, and after determining whether there is an abnormality in the learner's behavioral pattern, transmit the determination result to the coach interface 140 to request feedback related to the determination result. For example, when the coaching service server 120 determines that there is no abnormality in the learner's learning state, the coaching service server 120 may transmit the determination result to the coach interface 140 to provide positive feedback to the learner.

The coaching service server 120 may further provide information on the learner (e.g., educational background, learning items, learning progress, correct answer rate, feedback list provided so far, etc.) to the coaching interface 140.

The coaching interface 140 may receive the learner's behavioral pattern and the learner's handwriting input information from the coaching service server 120, and transmit as feedback a comment on the behavioral pattern which is input by a coach to the learner interface 100 or the coaching service server 120. The coaching interface 140 may request the coach to input a comment in response to reception of a determination result of the learner's behavioral pattern and/or abnormality as a result of determining whether there is an abnormality in the learner's behavioral pattern in the middle of receiving the learner's handwriting input information from the coaching service server 120. The coach may input a comment by checking the learner's handwriting input information using the coach interface 140, and may input the comment when the coach interface 140 receives a result of determining whether there is an abnormality. Since the coach interface 140 may simultaneously check handwriting input information of several learners, the coach may input comments on behavioral patterns of the several learners to the coach interface 140.

The coach interface 140 may recommend appropriate feedback for each learner's behavioral pattern and handwriting input information by learning the received behavioral patterns and handwriting input information for the several learners, and the coach's input feedback. The recommended feedback may be immediately transmitted to the learner interface 100 or the coaching service server 120 and provided to the learner in real time.

The coach interface 140 may assist the coach to input more appropriate comments by receiving and displaying further information about the learner from the coaching service server 120 or a separate external database (not shown).

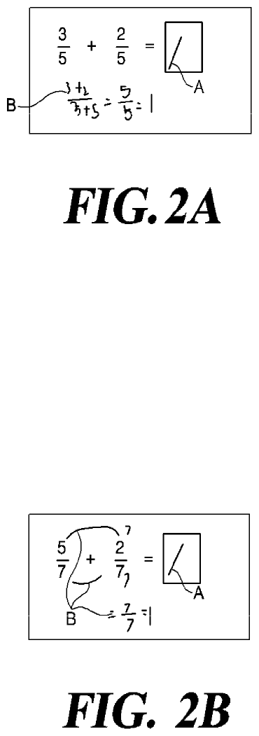

FIGS. 2A and 2B are exemplary diagrams illustrating handwriting input information according to one embodiment of the present disclosure.

FIGS. 2A and 2B each show a learning screen which a learner uses to learn as handwriting input information. Referring to FIGS. 2A and 2B, it may be seen that the learner interface receives a handwriting input written by the learner and displays the handwriting input in each of the answer area and the non-answer area. For example, in the learning screen of FIGS. 2A and 2B, the learner's written answer (A in FIGS. 2A and 2B) is indicated in the answer area, and the learner's solving process handwriting (B in FIGS. 2A and 2B) is indicated in the non-answer area.

The coaching service server may receive such handwriting input information, detect the learner's behavioral pattern, and determine whether there is an abnormality in the behavioral pattern. Referring to FIG. 2A as an example, the learner got the correct answer, but there is an error in the notation of the denominator area in the solving process, so the solving process of using the pattern for adding the denominator in addition of fractions with the same denominator is detected as the learner's behavioral pattern. As a result, it may be determined whether there is an abnormality. The coaching service server may immediately determine that there is an abnormality when such a behavioral pattern is detected, but may determine that there is an abnormality when errors are repeated in the process of solving such a problem.

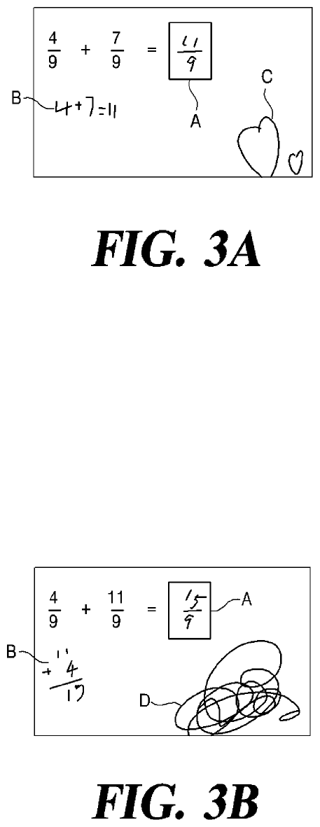

FIGS. 3A and 3B are exemplary diagrams for illustrating a method of detecting a behavioral pattern of a learner based on handwriting input information according to one embodiment of the present disclosure.

FIGS. 3A and 3B each show a learning screen which a learner uses to learn as handwriting input information. Referring to FIGS. 3A and 3B, it may be confirmed that the learner interface receives a handwriting input and displays the handwriting input on the learning screen. For example, in the learning screen of FIGS. 3A and 3B, the answer written by the learner (A in FIGS. 3A and 3B) is indicated in the answer area, and the learner's solving process handwriting (B in FIGS. 3A and 3B) and other handwriting (C in FIG. 3A and D in FIG. 3B) are indicated in the non-answer area.

Referring to FIG. 3A, the learner wrote the solving process and other handwriting together on the non-answer area. The learner's solving process is accurate, but in relation to the learning item, which is a mathematical item, the learner further inputs other handwriting (C in FIG. 3A), not numbers or mathematical expressions. Since C of FIG. 3A is difficult to be identified as number or mathematical expression, the coaching service server may detect a behavioral pattern in which an object different from the answer description type is input from the handwriting input information to determine that it is abnormal.

Referring to FIG. 3B, the coaching service server may detect a behavioral pattern that has a lot of handwriting inputs as a behavioral pattern of the learner by comparing the correct answer information (e.g., correct answer, answer description type, and solving process information) of the learning item in FIG. 3B. Alternatively, the coaching service server may distinguish the handwriting in the answer area, and the solving process and/or other descriptions in the non-answer area, and may detect a behavioral pattern that the learner has input an object different from the answer description type by detecting D in FIG. 3B, which is not related to the answer description for the learning item, which is a mathematical item.

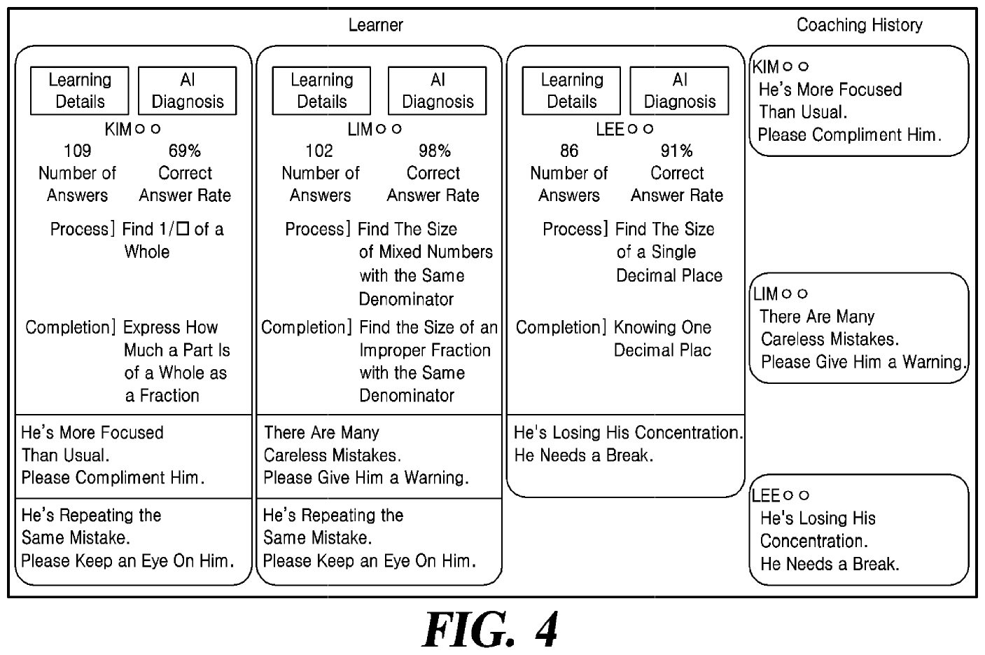

FIG. 4 is an exemplary diagram illustrating a coach interface according to one embodiment of the present disclosure.

The coach interface may display information about one or more learners performing learning, and the coach may use the coach interface to feedback comments on the behavioral patterns of one or more learners.

Referring to FIG. 4, the coaching interface may display information on one or more learners performing learning. As information about each learner, name (or nickname), learning item information (“answer number” in FIG. 4), learning progress (“progress” and “completion” items in FIG. 4), correct answer rate, and a list of feedback provided so far may be displayed together. The coaching interface may provide a “learning details” item to display a learning screen mirrored in the learner interface as handwritten input information of the learner. The coach interface may provide an “AI diagnosis” item to recommend comments on the learner's handwriting input information and/or on behavioral patterns and abnormal determination results. The coach interface may provide a “coaching history” item to display a list of comments that the coach has fed back so far.

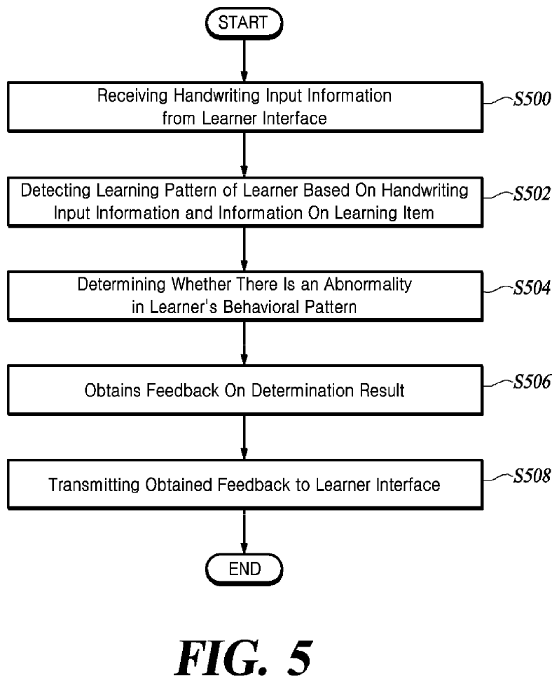

FIG. 5 is a flowchart illustrating a coaching service providing method according to one embodiment of the present disclosure.

The coaching service server receives handwriting input information of the learner from the learner interface (S500). The handwriting input information may be, for example, a learning screen on the learner interface which the learner uses to learn and a handwriting input signal, or may be the learning screen itself displaying the learner's handwriting input, but is not limited thereto.

The coaching service server detects a learning pattern of the learner based on the handwriting input information and information on a learning item learned by the learner (S502). The learning pattern may be, for example, a case where no handwriting input is input for a long time, a case where the handwriting input is input excessively, a case where the handwriting input is input too quickly, a case where the answer is repeatedly wrong, a case where an object unrelated to the answer or the solving process of the answer is input, a case where the answer is input at an appropriate speed and the answer is repeatedly corrected, and the like, but is not limited thereto.

The coaching service server determines whether there is an abnormality in the learner's behavioral pattern (S504).

The coaching service server obtains feedback on the determination result in step S504 (S506). The feedback may include both positive and negative feedback.

The coaching service server transmits the obtained feedback to the learner interface (S508).

Although it is described in FIG. 5 that the processes are sequentially executed in the flowchart of the present disclosure, this is merely illustrative of the technical idea of one embodiment of the present disclosure. In other words, since an ordinary skilled person in the art to which the embodiment of the present disclosure pertain may make various modifications and changes by changing the processes described in FIG. 5 or performing one or more of the processes in parallel without departing from the essential characteristics of the embodiment of the present disclosure, the present disclosure is not limited to the time-series order of FIG. 5.

Various implementations of the device, unit, process, step, etc. described herein may be realized by a digital electronic circuit, an integrated circuit, a field programmable gate array (FPGA), an application specific integrated circuit (ASIC), computer hardware, firmware, software, and/or a combination thereof. These various implementations may include an implementation by one or more computer programs executable on a programmable system. The programmable system includes at least one programmable processor (which may be a special purpose processor or a general-purpose processor) that is coupled to a storage system, at least one input device, and at least one output device to receive and transmit data and instructions therefrom and thereto. Computer programs (also known as programs, software, software applications or codes) contain instructions for the programmable processor and are stored in a “computer-readable recording medium”.

The computer-readable recording medium includes all types of recording devices in which data readable by a computer system is stored. The computer-readable recording medium may further include non-volatile or non-transitory mediums such as ROM, CD-ROM, a magnetic tape, a floppy disk, a memory card, a hard disk, an optical disk, and a storage device. In addition, the computer-readable recording medium may be distributed in a network-connected computer system, and computer-readable codes may be stored and executed in a distributed manner.

Various implementations of the systems and techniques described herein may be implemented by a programmable computer. Here, the computer includes a programmable processor, a data storage system (including a volatile memory, a non-volatile memory, or another type of storage system, or a combination thereof), and at least one communication interface. For example, a programmable computer may be one of a server, a network device, a set-top box, a built-in device, a computer expansion module, a personal computer, a laptop, a personal data assistant (PDA), a cloud computing system, and a mobile device.

According to one embodiment of the present disclosure, by obtaining the learner's handwriting input information is obtained from the learner interface, detecting the learner's behavioral pattern, and determining whether there is an abnormality in the learner's behavioral pattern, it is possible to analyze the behavioral patterns related to the learner's handwriting input.

According to one embodiment of the present disclosure, by transmitting the detected behavioral pattern and/or handwriting input information to the coach interface to receive a comment related to the behavioral pattern, it is possible to provide appropriate feedback to the learner based on the behavioral pattern and abnormality determination result.

Therefore, when using the coaching service providing method and the server according to one embodiment of the present disclosure, by analyzing the behavioral pattern related to the learner's handwriting input and providing feedback thereon, it is possible to provide a customized one-to-one coaching service to the learner even in a non-face-to-face situation and encourage learners to develop good learning habits.

Effects of embodiments of the present disclosure are not limited to the above-mentioned effects, and other effects not mentioned will be clearly understood by those skilled in the art from the foregoing descriptions.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A method, performed by a device, for providing coaching service, the method comprising:
receiving handwriting input information of a learner from a learner interface;
detecting a behavioral pattern of the learner based on the handwriting input information and information on a learning item which the learner performs learning;
determining whether there is an abnormality in the behavioral pattern; and
obtaining a feedback based on a determination result about the abnormality.

2. The method of claim 1, wherein the receiving of the handwriting input information includes:
receiving a learning screen which the learner performs learning on the learner interface as the handwriting input information.

3. The method of claim 1, wherein the information of the learning item includes classification information of the learning item.

4. The method of claim 1, wherein the information of the learning item includes a preset problem solving reference time. The method of claim 2, wherein the information of the learning item includes an answer area on the learning screen,

6. The method of claim 1, wherein the information of the learning item includes an answer description type.

7. The method of claim 1, wherein the information of the learning item includes a correct answer information.

8. The method of claim 1, wherein the determining whether there is the abnormality in the behavioral pattern includes:
determining that there is the abnormality in the behavioral pattern in sponse to detection of the behavior pattern corresponding to a case where it is determined that the learner is not trying to solve a learning question properly.

9. The method of claim 2, wherein the determining whether there is the abnormality in the behavioral pattern includes:
determining that there is the abnortnality in the behavioral pattern in response to detection of the behavior pattern corresponding to a case where it is determined that no handwriting input exists on the learning screen within a problem solving reference time of the learning item.

10. The method of claim 2, wherein the determining whether there is an abnormality in the behavioral pattern includes:
determining that there is the abnormality in the behavioral pattern in response to detection of the behavior pattern corresponding to a case where it is determined that there are many handwriting inputs on the learning screen compared to correct answer information of the learning item,

11. The method of claim 2, wherein the determining whether there is an abnormality in the behavioral pattern includes:
determining that there is the abnormality in the behavioral pattern in response to detection of the behavior pattern corresponding to a case where it is determined that a time when the handwriting input is inputted on the learning screen is earlier compared to a problem solving reference time.

12. The method of claim 2, wherein the determining whether there is the abnormality in the behavioral pattern includes:
determining that there is the abnormality in the behavioral pattern in response to detection of the behavior pattern corresponding to a case where a type of the handwriting input on the learning screen is determined to be different from an answer description type of the learning item

13. The method of claim 12, wherein the case where the type of the handwriting input on the learning screen is determined to be different from the answer description type of the learning item includes a case where it is determined that information recognized from the handwriting input is not a number or a mathematical expression though the answer description type is a number.

14. The method of claim 2, wherein the determining whether there is the abnormality in the behavioral pattern includes:
distinguishing an answer area and a non-answer area of the learner from a handwriting input on the learning screen based on the information of the learning item.

15. The method of claim 14, wherein the determining whether there is the abnormality in the behavioral pattern further includes:
determining that there is the abnormality in the behavioral pattern in response to detection of the behavior pattern corresponding to a case where it is determined that the handwriting input on the non-answer area is not a solving process of the learning item.

16. The method of claim 14, wherein the determining whether there is the abnormality in the behavioral pattern further includes:
determining that there is the abnormality in the behavioral pattern in response to detection of the behavior pattern corresponding to a case where it is determined that the handwriting input on the non-answer area is identified as the solving process of the learning item, and there is an error in all or part of the solving process.

17. The method of claim 1, wherein the obtaining the feedback includes:
sending the behavioral pattern and the handwriting input information to a coach interface; and
receiving a comment related to the behavioral pattern from the coach interface as the feedback.

18. The method of claim 17, further including:
sending information on the learner to the coach interface,
wherein the information on the learner includes at least one of an educational background, the learning item, a learning progress, a correct answer rate or a feedback list provided to the learner so far.

19. The method of claim 1, further comprising:
sending the feedback to the learner interface.

20. A coaching service server comprising:
one or more programmable processors; and
a computer readable storage coupled to the one or more programmable processors and having instructions stored therein,
wherein the instructions, when executed by the one or more programmable processors, cause the one or more programmable processors to:
receive handwriting input information of a learner from a learner interface;
detect a behavioral pattern of the learner based on the handwriting input information and information on a learning item which the learner performs learning;
determine whether there is an abnormality in the behavioral pattern; and
obtain a feedback based on a determination result about the abnormality.
